(19) United States
(12) Patent Application Publication
(10) Pub. No.: US 2006/0083828 A1
(43) Pub. Date: Apr. 20, 2006

(54) Method for dehydrating peppers or other products and puffing for food

(76) Inventors: Daniel S. Lena, Chicago, IL (US); Marie Lena, Chicago, IL (US)

Correspondence Address: PYLE & PIONTEK, 221 N. LASELLE STREET, SUITE 850, CHICAGO, IL, 60601, US

(21) Appl. No.: 11/250,955

(22) Filed: Oct. 14, 2005

Related U.S. Application Data
(60) Provisional application No. 60/619,205, filed on Oct. 15, 2004.

(51) Int. Cl. A23L 1/217

(52) U.S. Cl. 426/242

(57) ABSTRACT

A method for dehydrating edible thick skin vegetable foods such as fresh red bell peppers or beets then crisping, puffing or preparing them into a food ingredient and/or snack product is provided. The method includes: washing the peppers/beets or product to remove foreign materials and pesticide residue from the surfaces of the peppers; removing the stems and seeds of the peppers, cutting the peppers/beets into strips, rings. (Beet slices ⅛″ to 1/16″ thick) then drying the peppers/beets by hot air dehydrators; then frying the dried red peppers/beets into a crunchy/crispy/puffed food, food ingredient and/or snack product, then seasoning the re-dehydrating before packaging or serving.

This United States non-provisional patent application is a continuation-in-part of and claims the benefit of Provisional patent application filed on Oct. 15, 2004 and having Ser. No. 60/619,205, entitled “Method For Dehydrating/dry-roasting peppers, beets and high sugar vegetables and crisping/crunching/puffing For Food” and relates to the preparation of edible thick skinned vegetables such as peppers, and particularly red bell peppers and beets for a food or snack.

### FIELD OF THE INVENTION

This invention relates to the preparation of edible thick skinned high sugar vegetables such as peppers, and particularly red bell peppers, sweet beets, root vegetables and other vegetables for a food, ingredient in other foods, or snack.

### BACKGROUND OF THE INVENTION

It is known to pick the remaining September harvest green Melrose peppers. These peppers were generally handpicked, left whole and washed thoroughly. The whole Melrose peppers were strung together in a garland, using a needle and thread through the heavy stem end and hung to dry, first in the September sun, then as the weather cooled, were transferred and hung similarly in the shed or attic. The room was sealed shut, newspapers were placed on the floor to catch the moisture and drippings from the peppers. This method cannot be regarded as the most hygienic as seeds in the peppers often turned moldy depending on the moisture in the air.

Around December, the dried peppers were removed from strings, sorted, and moldy peppers discarded usually 75 to 80%. Peppers were then fried in a sauce pan of corn oil and lard until crispy and puffy, then removed from heat and seasoned with salt and garlic powder. The result is a “crispy, crunchy and puffed up” pepper In Italian “Pepperula Croccanti” with intense crunch and flavor. Although some peppers looked fine on the outside, when bitten into, some ½ to ¾ contained moldy seeds. However, some ¼ of the peppers were chewy and did not have the desired crispness.

### SUMMARY OF THE INVENTION

It was desirable to improve the process for making this pepper as a spice, an ingredient and as well as a healthy low-fat food, and to create/develop a new healthy vegetable pepper food or snack. All of the various above hand operations are made more efficient and suitable for commercial quantities. The peppers are washed, cored and deseeded if needed. For example, peppers would be deseeded whereas the beet would not. 100 lbs of fresh red bell peppers produces 80 lbs of sliced pieces (see FIG. 1). The desired pepper bodies are specifically cut with serrated edged knives not straight edged knives as straight edged knives will damage the damage the vegetable's delicate wall cut into specific pieces. The pieces are dehydrated for 2-3 days' time or equivalent drying. 100 lbs. of fresh produces 80 lbs. of sliced pieces that get 7 lbs. of final dried or dehydrated. Then the peppers can be stored or cooked. As they are now dried or dehydrated, the peppers can be stored indefinitely prior to cooking. When ready to package or serve, the dehydrated peppers are again dehydrated to remove any moisture gained during storage and then flash deep fried. The peppers are removed and oil drained and then seasoned. The peppers are allowed to rest for a period of time. This period of time could be from 10 minutes to 2 hours, with about 20 minutes being preferred. Before serving or packaging, the rested peppers are again dehydrated for a short period of time. At home this could be accomplished by spending a short time in a convection oven, say 10 minutes at 125 degrees F. After testing for quality and requisite crispness and puffiness, the peppers can, if desired, be again further seasoned and served or packaged.

Through trial and error, the process of drying becomes more sanitary and efficient with the use for example of a Viking convection oven (3-4 day process to dry). Dehydrated peppers are then fried and re-hydrated in extra virgin oil, then seasoned.

Preferably, the pieces are processed in two steps. Step 1. the pieces are dehydrated for 48 hours at 155 degrees F. and then 12 hours at 135 degrees F. 2½ days' time of equivalent drying. Step 2. the pieces are allowed to cool to room temperature then dry-roasted at 140 to 155 degrees F. for 1 hour time.

Product specifics: Sweet Red Pepper Chips and Sweet Beet Chips

Product Description:

Fresh red bell peppers/beets and sweet beets which as washed, cored, serrated edged sliced cut and dehydrated per specifications below.
Fresh sweet beets which are washed, peeled and serrated edged sliced cut to ⅛^{th} inch cut and dehydrated per specifications below.
   Organoleptic Evaluation:
Appearance: Uniformly red
Flavor: Fresh, typical of red bell pepper & sweet beets
Texture: Tender, typical of dehydrated red bell pepper & sweet beets
Odor: Typical of red bell pepper & sweet beets

Physical Evaluation:

| Hydrated Form (Strips): | Hydrated Form (Rings): |
|---|---|
| 3.5″ (+/−.50″) in length | 0.625″ (+/−.125″) thick |
| 1.75″ (+/−.375″) in width | |
| Dehydrated Form (Strips): | Dehydrated Form (Rings): |
| 3″ (+/−.50″) in length | No Specification |
| .50″ (+/−.375″) in width | |
| Moisture: | |
| .0% to 6.0% maximum | |

Microbiological Evaluation:

| | Values | Method |
|---|---|---|
| Standard Plate Count | 300,000/g max | B.A.M. 7^{th} ED |
| Yeast/Mold: | 300/g max | B.A.M. 8^{th} ED |
| Coliform: | 100/g max | B.A.M. 8^{th} ED |
| E. Coli: | Negative in 1 gram | B.A.M. 8^{th} ED |
| Salmonella | Negative in 25 grams | B.A.M. 7^{th} ED |

Natural Statement:

All ingredients must be 100% pure and natural.

Pesticides & Herbicides:

Produce in accordance with U.S. FDA limits for residues.

Packaging:

Product will be packed in moisture free, crush resistant containers.

Storage:

Dehydrated product is to be stored in a cool, dark and dry facility.

Then the peppers/beets can be stored prior to cooking. As they are now dehydrated and roasted, the peppers/beets can be stored indefinitely in an air tight sealed non-pours packaging prior to cooking. When ready to package or serve, the dehydrated peppers/beets are checked 0.0% to 6.0% maximum hydration and if necessary once again dehydrated to remove any moisture gained during storage. Submerging/flash deep fry in 80% olive oil 20% canola oil blend. Heated in a broad range of 220 degrees F. to 270 degrees F., narrow range of 235 degrees F. to 260 degrees F., or optimal range of about 250 degrees F. for two separate submerge sessions. This is also known as in/out fry-hold-fry cooking. Frying session #1 immediate non-stop submerge/remove or in/out of oil. After first frying session use an open air hold for broad range of 5 to 30 seconds, narrow range of 10 to 20 seconds, or optimal at about 15 seconds. Then frying session #2 for a broad range of 5 to 10 seconds, narrow range of 6 to 8 seconds, or optimal of about 7 seconds at 250 degrees F. The peppers/beets are removed and oil drained and then immediately seasoned with organic sea salt first the spices blend next. The peppers/beets are allowed to rest in a humidity controlled room for a period of time broad range of 0 to 45 minutes, narrow range of 10 to 30 minutes, or optimal at about 20 minutes. Before serving or packaging, if needed the rested peppers/beets are again dehydrated or common refrigerated for a short period of time broad to optimal range is based on the humidity in the ambient air. At home this could be accomplished by spending a short time in a convection oven, say optimally about 10 minutes at 125 degrees F. After testing for quality and requisite crispness and puffiness, the peppers/beets can, if desired, be again further seasoned. Immediate air tight packaging and then common refrigeration is suggested.

Through personal trial and error, with the use of forced air fans, open air sun sunlight, convection ovens and professional dehydrators, a process for over 35 years then becomes more sanitary and efficient with the personal use for example of a professional Viking convection oven (3-4 day process to dehydrate and dry roast). Dehydrated peppers/beets are then fried and re-hydrated in extra virgin oil, and canola oil blend then seasoned rested and packaged/served.

The invention can also be used to prepare vegetable and root vegetables, such as beets and particularly sweet beets.

### BRIEF DESCRIPTION OF THE DRAWINGS

FIG. 1 is a perspective view or photograph showing with dashed lines how the pepper is to be cut;

FIG. 1A is a schematic showing how a beet would be sliced;

FIG. 2 is a flow diagram illustrating one manner of carrying out the present invention; and

FIG. 3 is a flow diagram illustrating another manner of carrying out the present invention.

### DESCRIPTION OF THE PREFERRED EMBODIMENT

This invention will be described by way of example in connection with peppers/beets and particularly sweet red bell peppers. Of course, as noted in the prior provisional and herein other foods, fruits, vegetables and thick skinned edibles could be used.

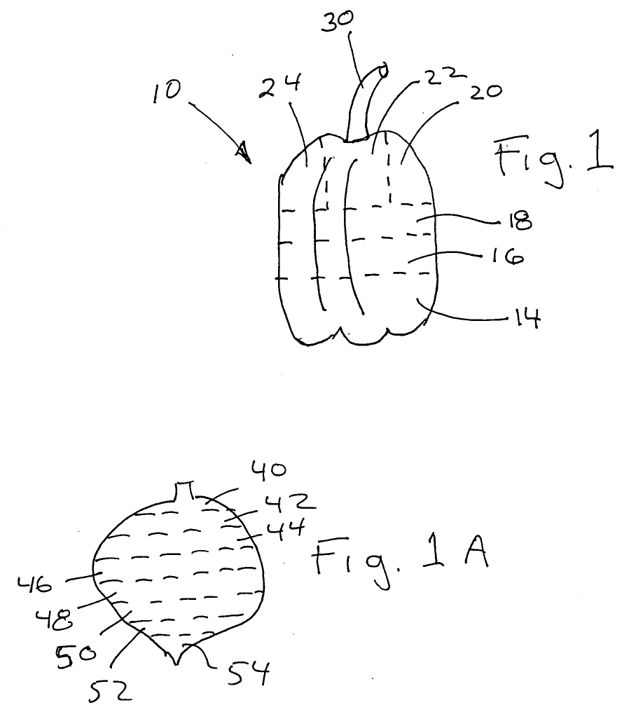

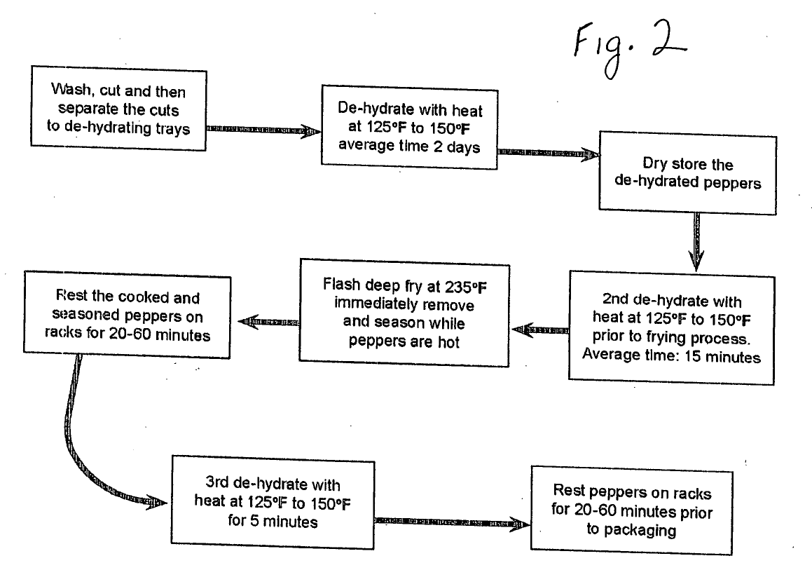

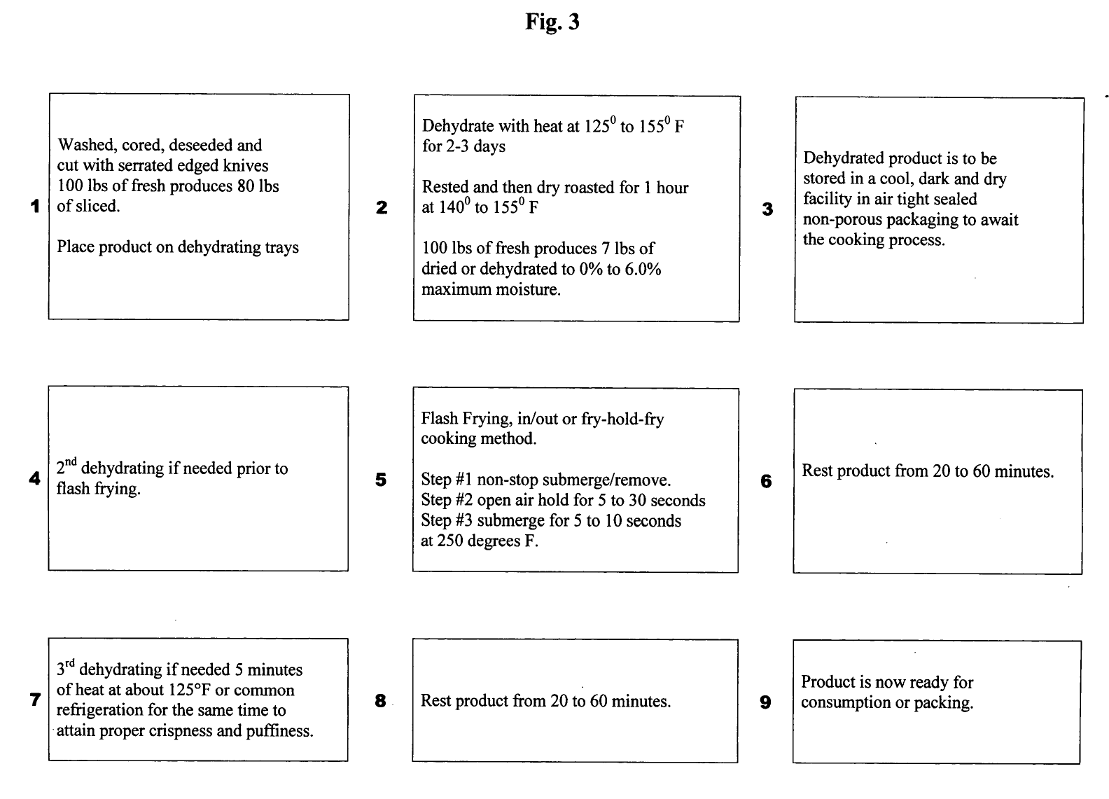

Sweet red bell peppers 10 are first triple washed and cut into three various shapes as per FIG. 1. The first cut is sliced from the bottom and becomes the end piece 14. Next cut yields 2-3 ring shapes 16, 18. The remaining pepper is placed on its' stem top and sliced downward into 4-5 flatter pieces called scoopers 20, 22, 24 for their ability to scoop up dip effectively. One average sized red bell pepper yields approximately 8 pieces. The remaining seeds and stem 30 are discarded 100 lbs of fresh red bell peppers yield 80 lbs of cut pieces. 100 lbs. of fresh produces 80 lbs. of sliced pieces that get 7 lbs. of final dried or dehydrated. This process can be duplicated with all red, green and yellow peppers, or any combination thereof, including hot or sweet peppers, various other suitable vegetables and even fruits, with cuts varying to accommodate product shapes.

If root vegetables are being prepared, such as beets, and particularly sweet beets, they must be cut into about ⅛″ to 1/16″ thick slices, for example, 40, 42, 44, 46, 48, 50, 52 and 54 (see FIG. 1A)

Peppers/beets are placed, according to shapes, on racks of hot air dehydrators and dried, say at 125-150° F. for 48-60 hours, until fully dehydrated. A typical drying would be for 48 hours at 140° to 155° F. and then 12 hours at 135° F. 2½ days' time of equivalent drying. Step 2. the pieces are allowed to cool to room temperature then dry-roasted at 155° F. for 1 hour time.

Peppers/beets are fully dehydrated when they are crisp and appear to contain 0.0% to 6.0% maximum moisture.

Dried peppers/beets are then stored in an air tight sealed non-pours packaging where they await the cooking process. Dried food product such as these can be stored in a cool, dry storage area without spoilage, indefinitely.

Immediately prior to cooking, if needed the peppers/beets are once again dried on racks of hot air dehydrators at a temperature of 125 degrees F. for approximately 15 minutes to remove any remaining moisture.

Deep fryers are brought to a temperature broad range of 220 to 270° F., with 235° F. being typical, and peppers/beets then go through our unique two step in/out flash deep fry technique with a momentary hold in the middle before going into virgin olive oil and vegetable oil (10 parts to one respectively) for approximately 30-60 seconds. We have found that using 80% extra virgin olive oil 20% canola oil blend, respectively for absolutely no longer then 15 seconds is preferred.

Peppers/beets are removed from fryer, drained, and placed in flat pans, similar to large cookie sheets, and seasoned with spices immediately.

Pans of cooked peppers/beets are allowed to rest on racks for 10 to 30 minutes (we found 20-60 minutes rest being preferred).

If needed prior to packing, rested peppers/beets are once again placed in dehydrators with heat at about 125° F. for about 5 minutes or common refrigeration to attain proper crispness and puffiness. Immediate air tight packaging and then common refrigeration at is suggested.

Peppers/beets are allowed to rest on racks for 10 to 30 minutes, (again we have found 20-60 minutes rest being preferred), and then they are ready for consumption or packing.

Optionally, several alternatives are available for packaging depending on end consumption. For “catering-style” events, a serving tray similar to supermarket raw vegetable or crudités trays are covered and secured with a see-through plastic “clam shells”. For mass packaging, product is placed into Mylar foil bags, mechanically puffed with nitrogen or other moisture-reducing agent, then heat sealed, similar to higher-end potato or vegetable chips found in specialty food stores or gourmet sections of the supermarket. The packaging can vary based on preferences of buyers and retailers. This may include cellophane bags, waxed bags, sealed waxed bags inside boxes (like snack crackers), or individual serving containers such as wax-coated paper cartons or clam-shell-style clear plastic containers. A desiccant (drying agent) may be needed or added if some packaging requires it. If retailer chooses to pack product themselves, such as a Whole Foods or Trader Joe's, product can be boxed and shipped in bulk. When restaurants choose to use the product as a menu item, an ingredient or spice, the product can be boxed and shipped in bulk.

In the unlikely event any product is left over and exposed to the air for longer than twenty-four hours, product may lose some crispness. To reestablish crispness, the product can be placed in a sealed container then common refrigeration at is suggested for 15-25 minutes before consuming. Also to re-establish crispness, product can be placed on a cookie sheet in a convection oven at a temperature of 125° F. for approximately 5 minutes, removed, and allowed to rest for 5-10 minutes before consuming.

While preferably the food used is a sweet red bell pepper other edible skin vegetable foods could also be processed by this method and a snack food or used as seasoning other foods, or served as a side dish. Examples of other type vegetables are the pepper family, including yellow and green and other type peppers, such as Melrose, Anaheim, varieties of hot peppers, even fruit such as all varieties of apples.

What is claimed is:

1. A method for preparing an edible skinned vegetable by a drying process, comprising:
washing the vegetables to remove foreign materials and pesticide residue from the surfaces of said vegetable;
separating seeds from the washed vegetable;
cutting said vegetable into pieces; and
drying said pieces by hot air dehydrators.

2. A method for preparing an edible skinned vegetable made according to claim 1, comprising the further steps of cooking said pieces into a crunchy/crispy/puffed food and snack product, seasoning said cooked pieces, and packaging said cooked pieces.

3. A method as in claim 2, further comprising opening said packaging and serving said cooked pieces.

4. A method as in claim 3, comprising collecting said cooked pieces not consumed and re-dehydrating or common refrigerating of said cooked pieces to restore crispness.

5. The method of claim 1, comprising the step of using hot air of at least 125° F. for drying said pieces.

6. The method of claim 1, comprising the step of drying said pieces for at least 48 hours.

7. The method of claim 1, comprising the step of drying said pieces and then dry roasting for about 1 hour to produce roasted pieces.

8. The method of claim 1, comprising the step of drying said pieces to generally contain 0.0% to 6.0% moisture.

9. The method of claim 2, wherein said cooking comprises the two step submerge hold submerge method of flash fry cooking the said pieces.

10. The method of claim 1, comprising the further step of storing in air tight sealed non-porous packaging the dried dehydrated said pieces.

11. The method of claim 10, comprising the step of unpacking the stored said pieces and again dehydrating said pieces for a short time.

12. The method of claim 10, comprising dehydrating for about 10 minutes at about 125° F.

13. The method of claim 1, wherein said edible skinned vegetable comprises a pepper.

14. The method of claim 1, wherein said edible skinned vegetable comprises a beet.

15. A method as in claim 1, comprising:
drying said pieces using hot air of at least 125° F. for drying said pieces;
drying said pieces for at least 48 hours;
drying said pieces to generally contain 0.0% to 6.0% maximum moisture; and
cooking said pieces into a crunchy/crispy/puffed food and snack product;
seasoning said cooked pieces; and
packaging said cooked pieces.

16. A method as in claim 15, further comprising opening said packaging and serving said cooked pieces.

17. A method as in claim 15, further comprising collecting said cooked pieces not consumed and re-dehydrating and/or refrigerating said cooked pieces to restore crispness.

18. The method of claim 15, wherein cooking comprises the two step submerge hold submerge method of flash frying said pieces.

19. The method of claim 15, wherein cooking comprises roasting said pieces for an hour after drying.

20. The method of claim 15, wherein the step of packaging comprises storing in air tight sealed non-porous packaging the dried dehydrated said pieces.

21. The method of claim 20, comprising the step of unpacking said stored pieces and again dehydrating said pieces for a short time.

22. A method as in claim 1, wherein said edible skinned vegetable is a pepper.

23. A method according to claim 22, comprising the further steps of seasoning the cooked peppers, re-dehydrating the peppers for a minimum period of time and serving or packaging the peppers.

24. The method of claim 22, comprising the steps using one of hot air of at least 125° F. and not more than 155° F. for drying said pieces, drying said pieces for at least 48 hours then dry roasting for 1 hour, and drying said pieces to generally contain 0.0% to 6.0% maximum moisture.

25. The method of claim 22, wherein said peppers are sweet peppers.

26. The method of claim 25, whereas said sweet peppers are red bell peppers.

27. A method for preparing a food for uses as one of an ingredient and snack, comprising:
washing the food to remove foreign materials and pesticide residue from the surfaces of the food;
separating the desired portion from the washed food;
cutting the desired portions into pieces;
drying the pieces by hot air dehydrator puffing the food; and
seasoning the pieces, re-dehydrating the pieces for a minimum period of time and serving or packaging the pieces.

28. A method as in claim 27, further comprising opening said packaging and serving said pieces.

29. A method as in claim 28, for collecting said pieces not consumed and re-dehydrating and/or common refrigeration said pieces to restore crispness.

30. The method of claim 27, comprising the step of using one of hot air of at least 125° F. for drying said pieces, drying said pieces for at least 48 hours, then dry roasting said pieces for 1 hour, and drying said pieces to generally contain 0.0% to 6.0% maximum moisture.

31. The method of claim 27, wherein packaging comprises the step of storing in air tight sealed non-porous packaging the dried dehydrated said pieces.

32. The method of claim 27, comprising the step of submerge hold submerge flash fry for cooking the stored said pieces.

33. The method of claim 27, comprising further roasting said pieces after drying.

34. A food snack comprising an edible skinned food, said edible skinned food having been washed and deseeded, if the seeds are not being utilized, said edible skinned food having been cut into one or more of a ring, end and scoop pieces, said edible skinned food pieces having been dehydrated, having been one of flash fried and roasted, and having been seasoned, rested and one of packaged and served.

35. A food ingredient comprising an edible skinned food, said edible skinned food having been washed and deseeded, said edible skinned food having been cut into one or more of a ring, end and scoop pieces, said edible skinned food pieces having been dehydrated, having been one of flash fried and roasted, and having been seasoned, rested and one of packaged and served.

36. A food snack comprising an edible food, said edible food having been washed and non-used portions removed, said edible food having been cut into one or more pieces, said edible food pieces having been dehydrated, having been one of flash fried and roasted, and having been seasoned, rested and one of packaged and served.

37. A food snack as in claim 36, wherein said edible food comprises one of a pepper, sweet pepper, and red bell pepper.

38. A food snack as in claim 36, wherein said edible food comprises a beet.

39. A food ingredient comprising an edible food, said edible food having been washed and non-used portions removed, said edible food having been cut into one or more pieces, said edible food pieces having been dehydrated, having been one of flash fried and roasted, and having been seasoned, rested and one of packaged and served.

40. A food ingredient as in claim 39, wherein said edible food comprises one of a pepper, a sweet pepper, and red bell pepper.

41. A food ingredient as in claim 39, wherein edible food comprises a beet.

42. A food as in claim 1, wherein said cutting is done with a serrated edge.

43. A food as in claim 1, wherein said food is fried.

44. A food as in claim 43, wherein said food is submerged hold submerged fried.

45. A food as in claim 1, wherein said food is roasted after drying.
